(19) United States
(12) Patent Application Publication
(10) Pub. No.: US 2016/0104256 A1
(43) Pub. Date: Apr. 14, 2016

(54) System and Method for Event Beverage Estimation

(71) Applicant: Lavell Jackson, Elizabethtown, KY (US)

(72) Inventor: Lavell Jackson, Elizabethtown, KY (US)

(21) Appl. No.: 14/883,513

(22) Filed: Oct. 14, 2015

Related U.S. Application Data
(60) Provisional application No. 62/063,516, filed on Oct. 14, 2014.

(51) Int. Cl. G06Q 50/12; G06Q 30/06

(52) U.S. Cl. CPC G06Q 50/12; G06Q 30/0633

(57) ABSTRACT

A method and computer application which helps a user estimate the amount of beverages, specifically alcoholic beverages needed for a live event. The method of the present invention, executed on a computing device provides a user with the ability to figure out what exactly their guests like or would prefer to drink at the event, whether the beverages of choice would be alcohol related or another type of beverage and an event estimate of how much alcohol and/or other beverages are needed for their event so they can go out and purchase the alcoholic beverages themselves for a much cheaper price than paying for a full open bar.

### CROSS REFERENCE TO RELATED APPLICATIONS

This application claims priority from U.S. Patent Application Ser. No. 62/063,516, entitled “System and Method for Event Beverage Estimation”, filed on 14 Oct. 2014. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to the estimation and forecasting of product needs for events. More specifically, the present invention relates to the forecasting and estimation of food and beverage products for a live event.

### BACKGROUND OF THE INVENTION

Many live events provide beverage functions/services that include adult drinks for participants/attendees. These live events typically include weddings, birthdays, and business parties where a cash bar is offered.

One important issue is who pays for the drinks. There are three main scenarios: (1) a cash bar (a.k.a. a no-host bar): Attendees pay for their own drinks; (2) a cash bar with tickets: The host issues vouchers to attendees for a limited number of free drinks, and attendees pay for any further drinks themselves; and (3) a host bar (a.k.a. an open bar): The host pays for all drinks, either by the hour, by the bottle, by the drink, or per person.

Choosing among the several options is influenced by several factors. One such factor is etiquette. Providing a cash bar at a function such as a wedding reception is generally considered poor etiquette in the United States.

Another such factor is cost. A cash bar is the least expensive option for a host. However, there are alternatives between a cash bar and a fully open bar that can limit costs. The host can set a hard limit on cost, beyond which all beverages have to be paid for by attendees. The host can specify that specific beverages, such as a few selected types of wines and beers, are paid for by the host, and that attendees pay for all other types of drinks. The host can set a time limit for an open bar, beyond which it reverts to being a cash bar. Or more complex combinations of these can be employed.

Cash bars have their problems for caterers and venue managers. One major problem is the possibility of theft. To prevent this, managers can set up cashiers, who take money and issue drinks tickets, separate from the serving staff who actually serve drinks.

Open bars have problems for hosts, in that they can result in an increased number of intoxicated, and potentially obnoxious and aggressive, attendees, as compared to other options. With open bars, the level of waste also increases (which is reflected in increased costs to the host). Since attendees do not pay for their drinks, they often do not consider them to be as valuable as they would if they had paid for them themselves. This results in drinks being abandoned or forgotten, or simply discarded by guests who leave their drinks (as they go and do something else) after only partly consuming them and then replace them with fresh ones rather than finishing the drinks that they already had.

Some venues, such as hotels, subject to the terms of their liquor licenses, may allow attendees to bring their own alcoholic drinks to beverage functions. However, they may also charge attendees a fee, usually charged per bottle (either at a flat rate or as a percentage of the bottle's price), for doing so, known as corkage.

Most people would purchase the alcohol themselves but they typically have trouble determining what kind and type of alcohol their guests like and how much to purchase. Therefore, what is needed is an easy way for a person to handle this issue themselves quickly and cheaply. This can be done by using a computer program, or more conveniently an App. which allows user to find out what type/king of alcohol guests attending an event like and help estimate how much they would need for their event.

### DEFINITIONS

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society.

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“Cash bar” is defined as a bar, such as one at a large party, where drinks are sold by the glass.

“Corkage” is defined as a charge made by a restaurant or hotel for serving wine that has been brought in by a customer.

“Beverage functions”, in catering, beverage functions are functions where beverages are served.

“Drink mixers” or mixers” are the non-alcoholic ingredients in mixed drinks and cocktails.

A “Live Event” is defined as anything that takes place or happens in real time where two or more people interact, in person at a specific, shared location.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

“RSVP”, in the context of social invitations, is a request for a response from the invited person or people. It is an initialism derived from the French phrase Répondez s'il vous plaît, literally “Reply if it pleases you” or “Reply please”.

A “web application” or “web app” is any application software that runs in a web browser and is created in a browser-supported programming language (such as the combination of JavaScript, HTML and CSS) and relies on a web browser to render the application.

### SUMMARY OF THE INVENTION

The present invention is a method and computer application which helps a user estimate the amount of beverages, specifically alcoholic beverages needed for a live event. The method of the present invention, executed on a computing device provides a user an event estimate of how much alcohol is needed for their event so they can go out and purchase the alcoholic beverages themselves for a much cheaper price than paying for a full open bar. The present invention also helps the people figure out what exactly their guest like or would prefer to drink at the event, whether it be alcohol related or another type of beverage.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a flow chart of the process of the present invention using the methods of the present invention to create the visual simulation on a smart phone and the RSVP system.

FIG. 2 is an illustrative screen shot of a smart phone application using the methods of the present invention to create the visual simulation on a smart phone and the RSVP system.

FIG. 3 is an illustrative screen shot of a smart phone application for the selection of beer by a guest using the RSVP system.

FIGS. 4-5 are illustrative screen shots of a smart phone application for the selection of mixed drinks by a guest using the RSVP system.

FIG. 6 is an illustrative screen shot of a smart phone application for the selection of wine by a guest using the RSVP system.

FIG. 7 illustrates the basic user/host event set up screen for establishing an event, bar parameters, and wine and champagne drink offerings.

FIG. 8 illustrates the beer offering and setup/display screen of the present invention.

FIGS. 9, 10, and 11 illustrate the mixed drink display which allows a user/host to select one or more mixers to complement an offered or RSVP requested alcohol type.

FIG. 12 illustrates a sample Drink Report generated by the application of the present invention.

FIG. 13 illustrates a sample Drink Shopping Report generated by the application of the present invention.

FIG. 14 illustrates a sample drink percentage report/forecast generated by the present invention.

FIG. 15 illustrates a sample drinks required report/forecast based on guest choices generated by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The present invention is a method and computer application which helps a user estimate the amount of beverages, specifically alcoholic beverages needed for a live event. The method of the present invention, executed on a computing device, provides a user an event estimate of how much alcohol is needed for their event so they can go out and purchase the alcoholic beverages themselves for a much cheaper price than paying for a full open bar. The present invention also helps the people figure out what exactly their guest like or would prefer to drink at the event, whether it be alcohol related or another type of beverage.

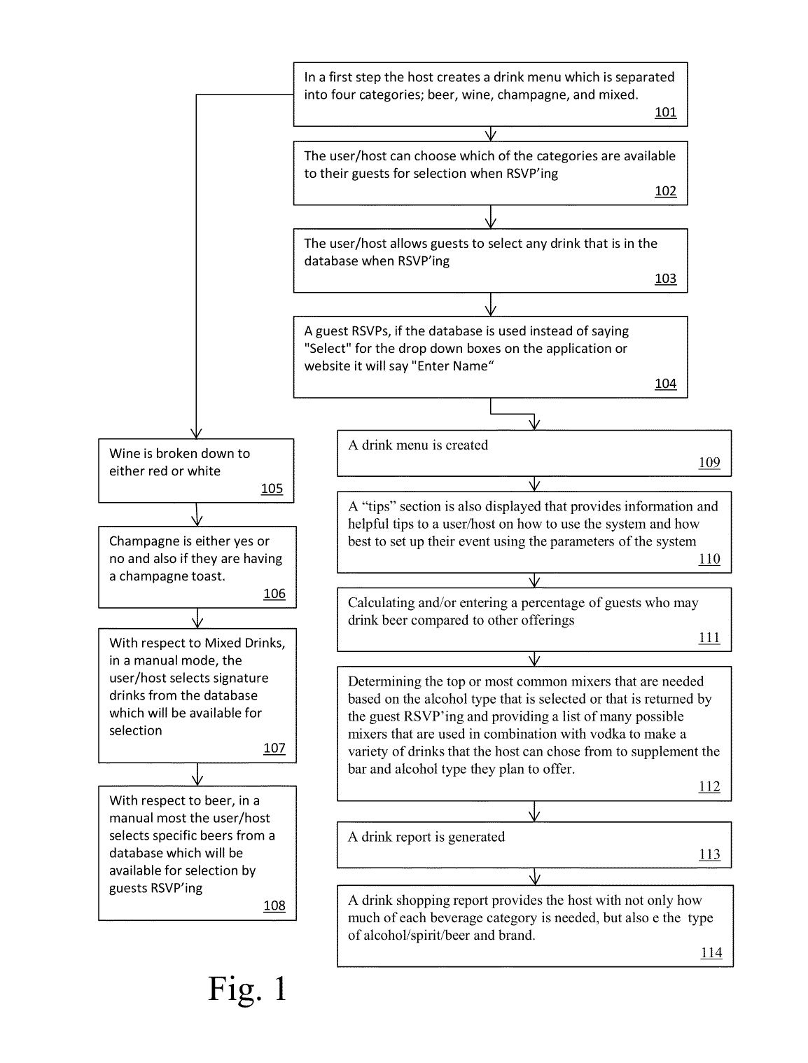

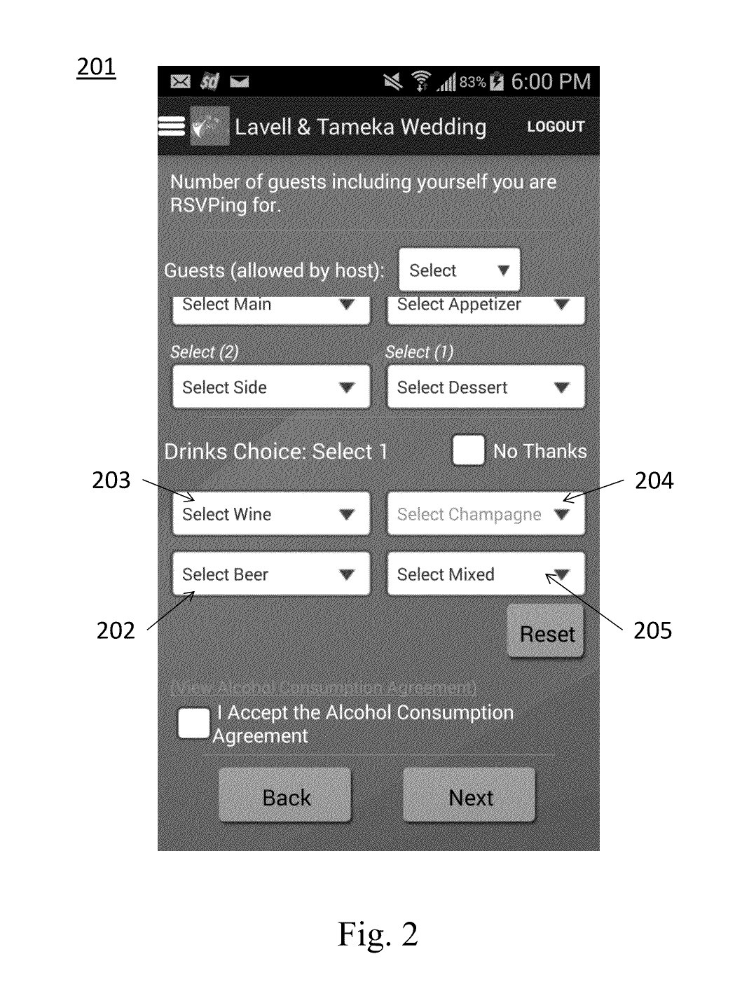

The method of the present invention is embodied in an event management and RSVP system where users/hosts can create their event and let guests RSVP to the event either online or using an app or application executed on a mobile computing device or platform which can run any operating system. In a first step 101 the host creates a drink menu 201 as shown in FIG. 2, which is separated into four categories; beer 202, wine 203, champagne 204, and mixed 205. The user/host can choose which of the categories are available to their guests for selection when RSVP'ing 102, see FIG. 1.

The present invention also can just be used for informational purposes. In this embodiment, if a user/host wanted to get an idea of what their guests are drinking or to report to a venue that is still providing the bar, the present invention would provide useful in estimating the amount and types of beverages to be served. The user/host can use the information (data) the present invention provides and pass it on to the venue for preparation of what may be needed or expected and also to use to determine the expected or anticipated costs of the beverage service or to ensure billing is in line with the expectation and estimation.

In the database the user/host allows guests to select any drink that is in the database when RSVP'ing 103. When a guest RSVPs, if the database is used instead of saying “Select” for the drop down boxes on the application or website it will say “Enter Name” 104.

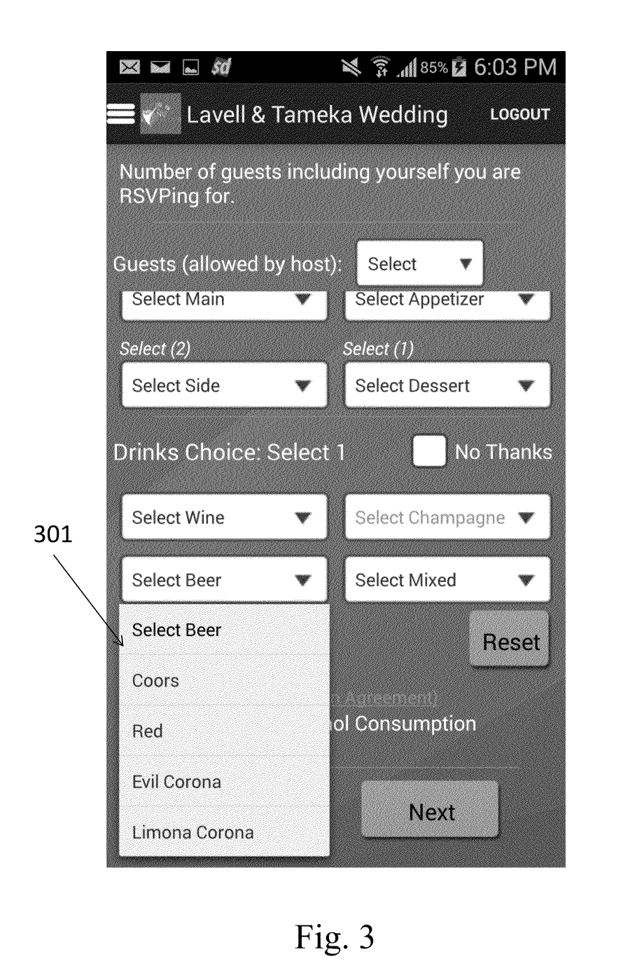

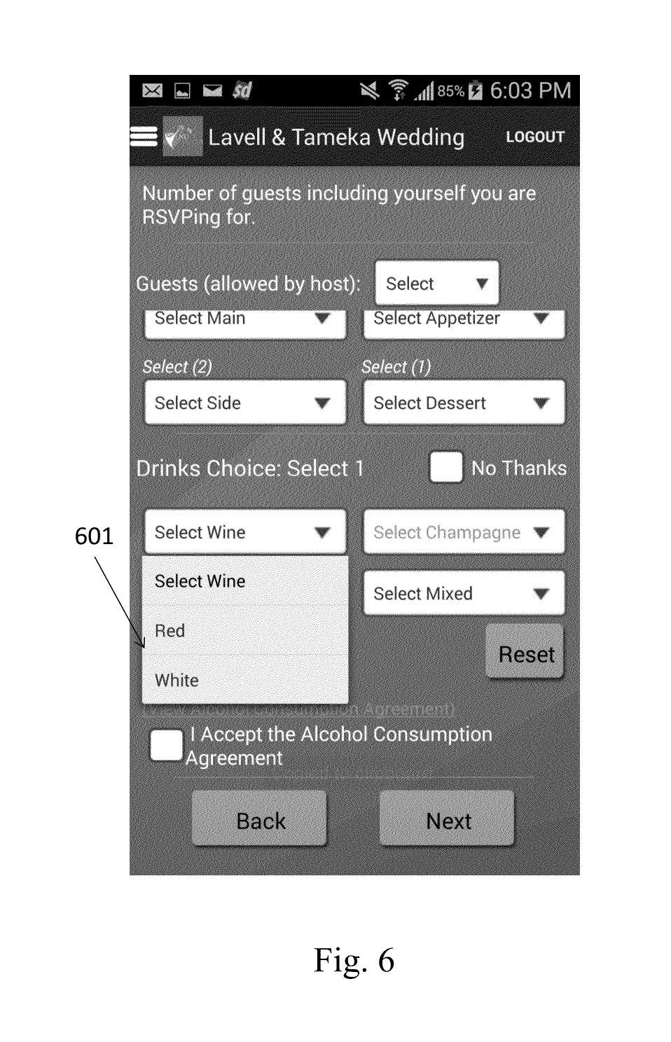

Wine selection 105 is broken down to either red or white 601, see FIG. 6. With respect to beer, in a manual most the user/host selects specific beers from a database 108 which will be available for selection by guests RSVP'ing 301, see FIG. 3. Champagne is either yes or no and also if they are having a champagne toast 106. The app allows guests to select any drink that is in the database and has been selected as an option by the host when RSVP'ing.

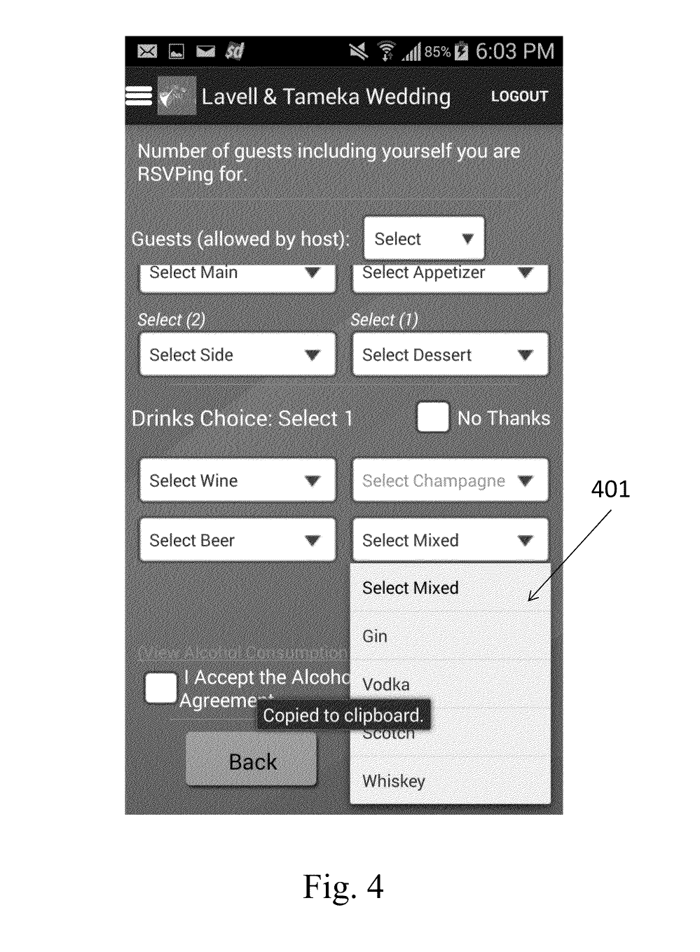

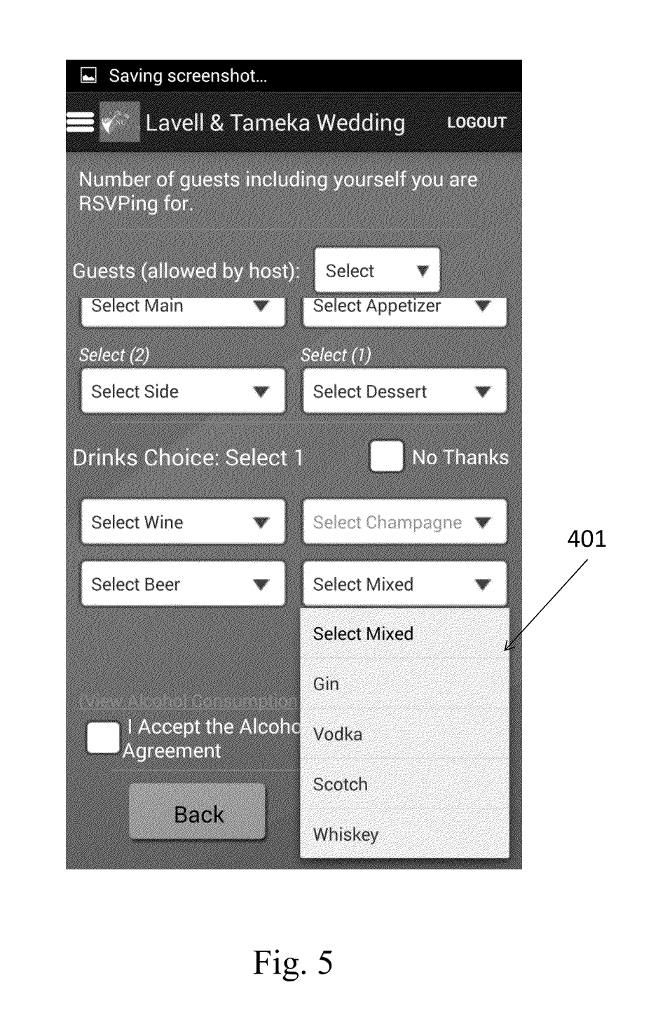

With respect to Mixed Drinks, in a manual mode, the user/host selects signature drinks from the database which will be available for selection 107 by guests RSVP'ing 401 as shown in FIGS. 4-5. The user/host selects the alcohol type(s) which will be available for selection by guests RSVP'ing. If mixed drinks are selected by Alcohol Type, the system offers a list of the top mixers with each alcohol type and helps estimate how much of each mixer is needed.

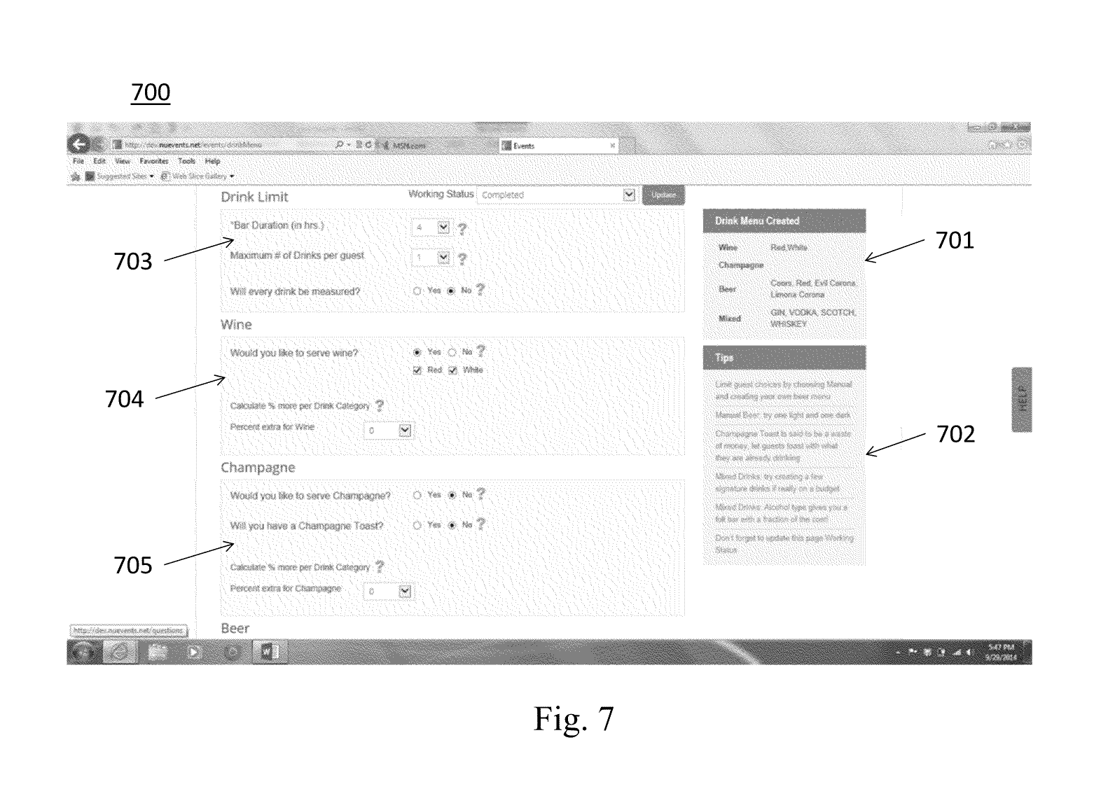

Now referring to FIG. 7, a drink menu 701 has been created 109 and is show on the upper right of the display screen 700 of the graphical user interface (GUI) of a computing device. In this embodiment, the drink menu consists of wine (red and white), champagne, beer (three kinds), and mixed drinks from four types of spirits. A “tips” section 702 is also displayed 110 that provides information and helpful tips to a user/host on how to use the system and how best to set up their event using the parameters of the system.

Now referring to FIG. 7, under drink limit 703, the user/host can set the time the bar will be open in a duration of hours as well as a whether drinks will be measured and setting maximum number of drinks per guest to control cost and limit the potential for waste or associated problems with those who may drink excessively.

Under the wine option 704, the user/host can elect to serve or not serve wine, and also limit the offering to red, white or both wines. The system also provides for calculating and/or entering a percentage of guests who may drink wine compared to other offerings.

Under the champagne option 705, the host/user can elect to serve or not serve champagne, and also whether there will be a champagne toast at the event. The system also provides for calculating and/or entering a percentage of guests who may drink champagne compared to other offerings.

The wine and champagne displays 704 and 705 will also provide the ability to use the drink database, in a manual mode, where guests can start to type in a name of the wine or champagne and select it for the event.

In another embodiment, the host will be able to do the signature drink for both of these categories as well.

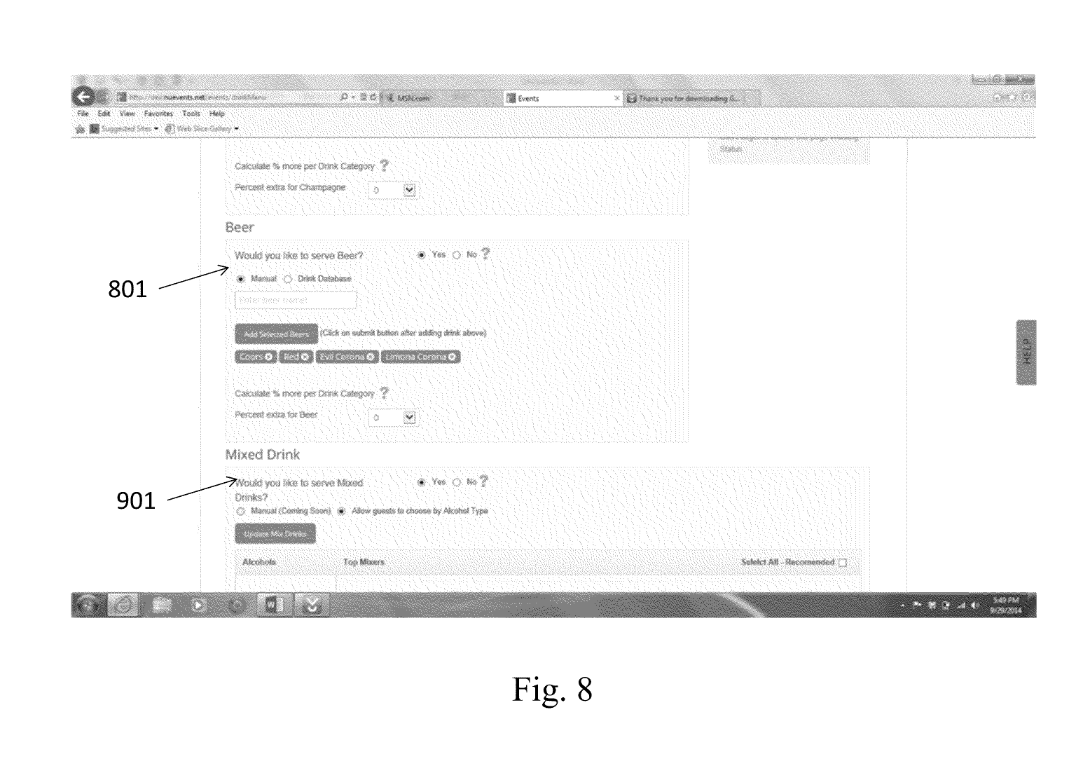

Now referring to FIG. 8, under the beer option 801, the user can elect a manual option to enter beer names/types or they can elect to choose from the drink database to select beer in the database. Once a beer name is entered or selected, the user adds the selected beer to their event offering and the name appears in a list below the add/selection option button. The system also provides for calculating and/or entering a percentage of guests who may drink beer compared to other offerings 111.

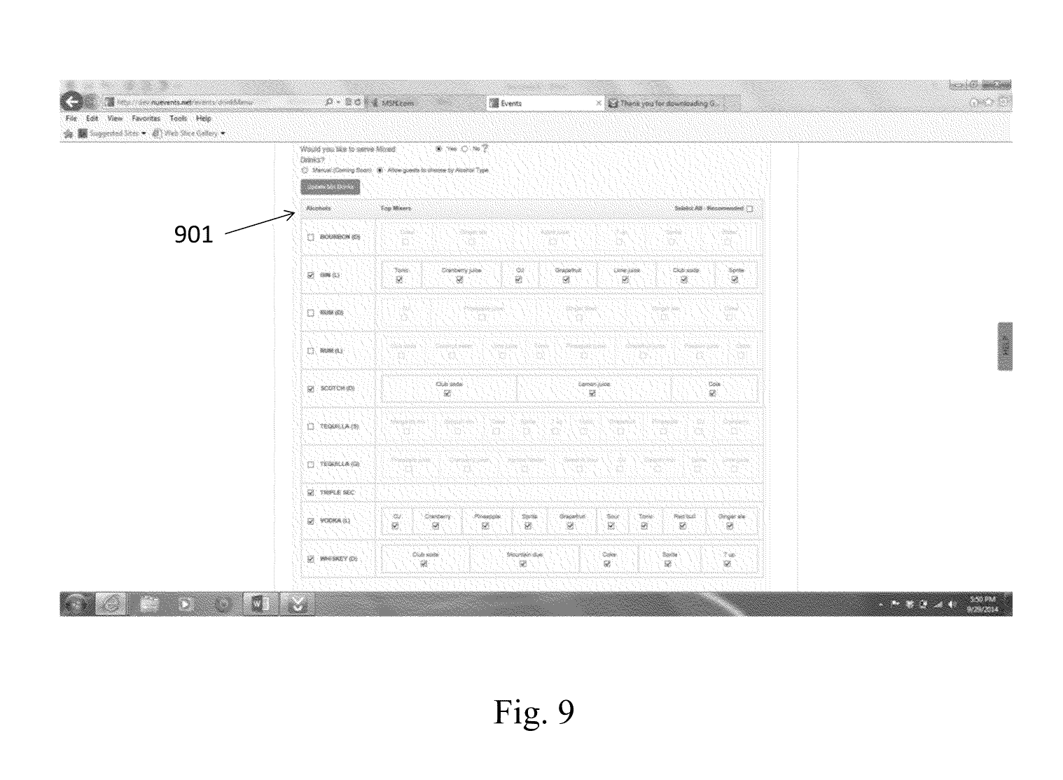

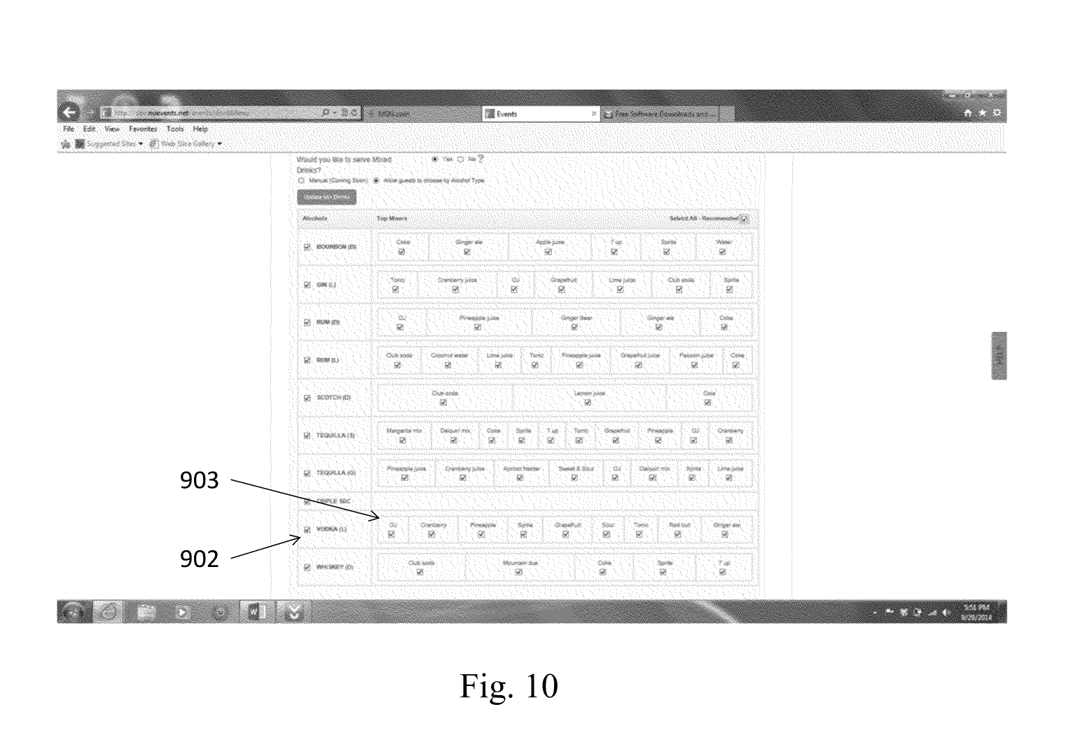

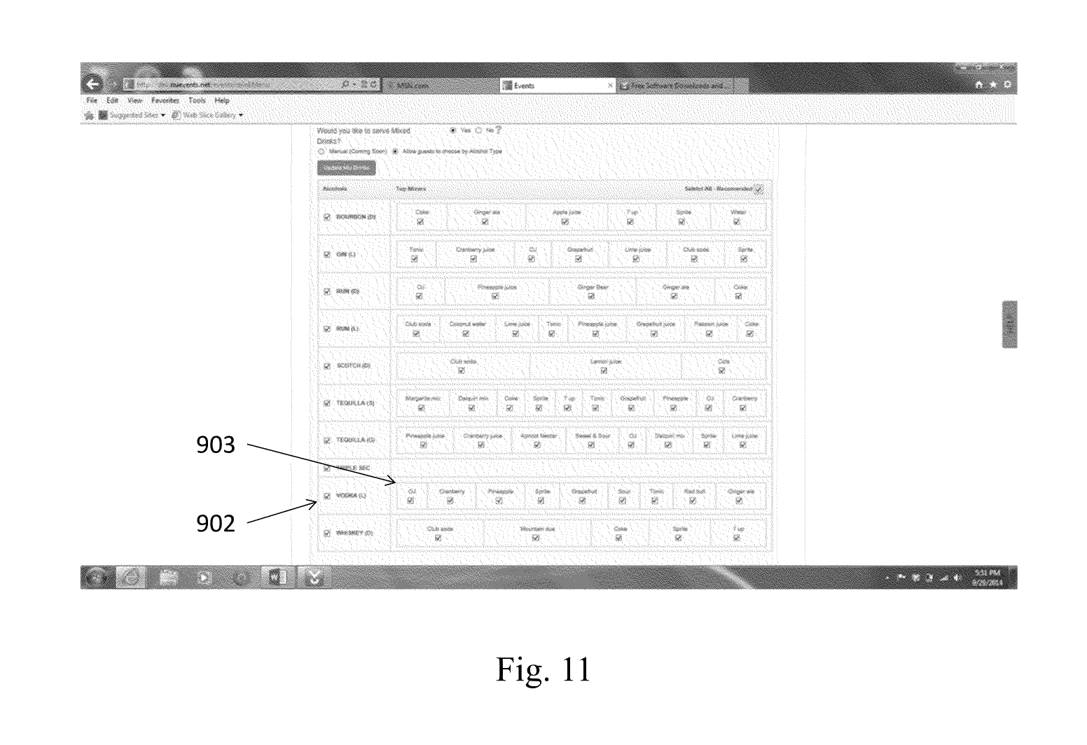

Referring to the bottom of FIG. 8 and FIG. 9, under the mixed drink option 901 the host/user can elect to serve or not serve mixed drinks. Under a manual option the user can enter the name of the alcohol/spirit type or they can elect to allow the guest to choose the alcohol type they want to have offered to them or anticipate drinking. As shown on FIGS. 9-11, the system determines the top or most common mixers that are needed based on the alcohol type that is selected or that is returned by the guest RSVP'ing 112. For example, if a number of guests RSVP and request a vodka drink 902, the system provides a list of many possible mixers 903 that are used in combination with vodka to make a variety of drinks that the host can chose from to supplement the bar and alcohol type they plan to offer.

For all the four beverage categories, if the guest tries to enter a signature drink, name of alcohol, wine, champagne, or beer, they will still be able to add it manually and it will add it to the event and reports. The admin of website will be notified or any additions to the beverage list as a result of a guest's entry. In this embodiment, wine is not limited to red or white and champagne is not limited to just yes or no.

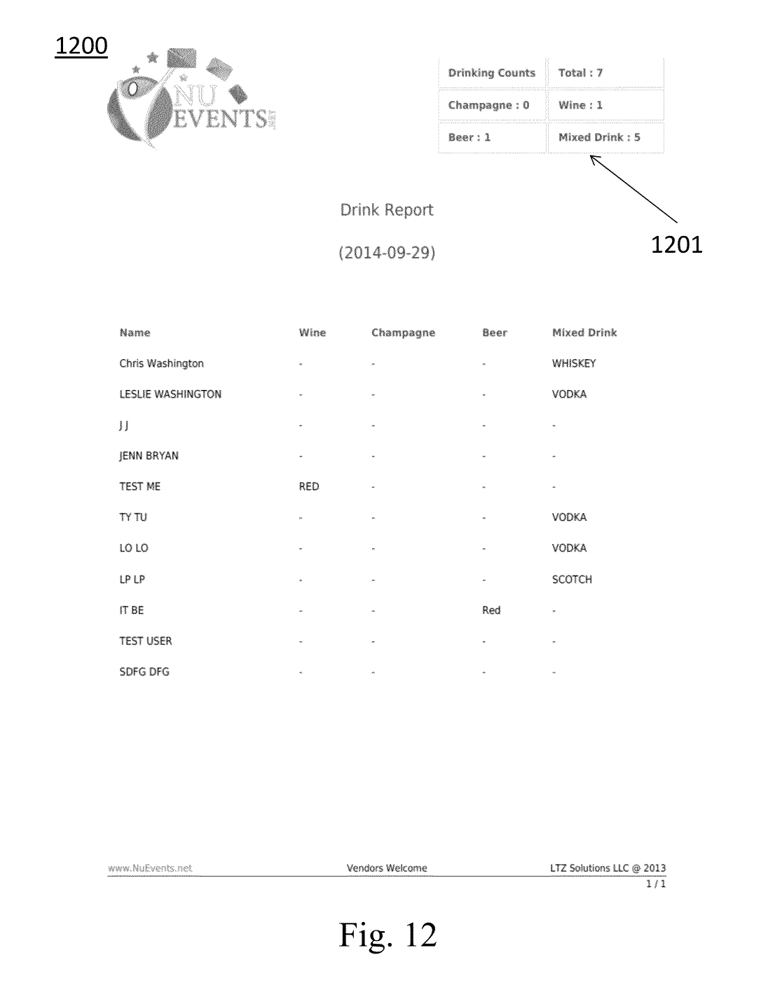

Now referring to FIG. 12, a drink report 1200 for an exemplary event is generated ad shown 113. The report includes the names of the guest who have submitted an RSVP for the event and their drink selection. The report also includes a drink summary 1201 in the upper right calculating a total drink count and breaking down the total drink count by the number of drinks need in each drink category. The drink report 1200 will list the amount needed in ounces but can cover all type of measurements. The drink report 1200 will also tell the user/host by bottle size of 750 ml how many bottles of each is needed to supply the event by rounding up to the nearest bottle so that there is no shortage.

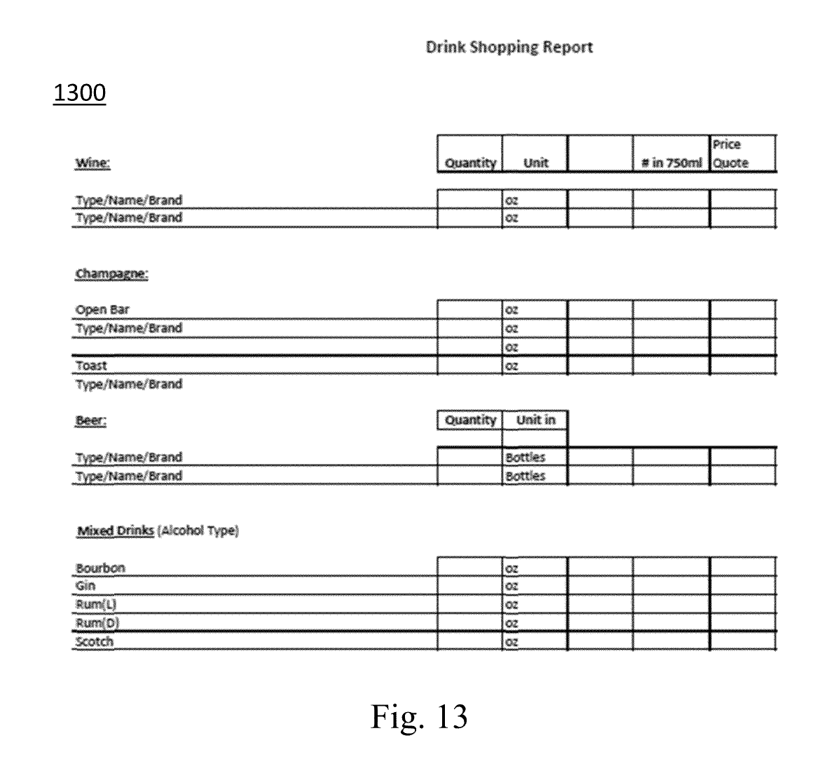

The drink shopping report 1300 is generated and shown 114 in FIG. 13 will provide the host with not only how much of each beverage category is needed, but also have the ability to tell the host what type of alcohol/spirit/beer is needed by name of the drink or brand of alcohol.

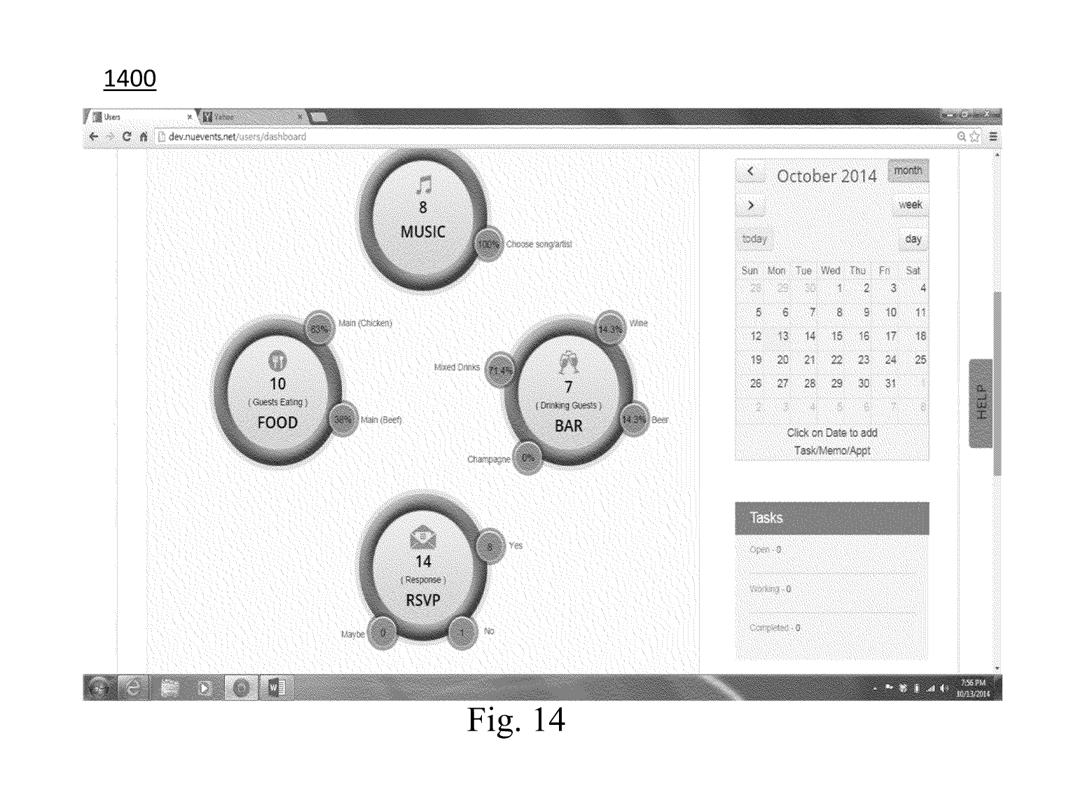

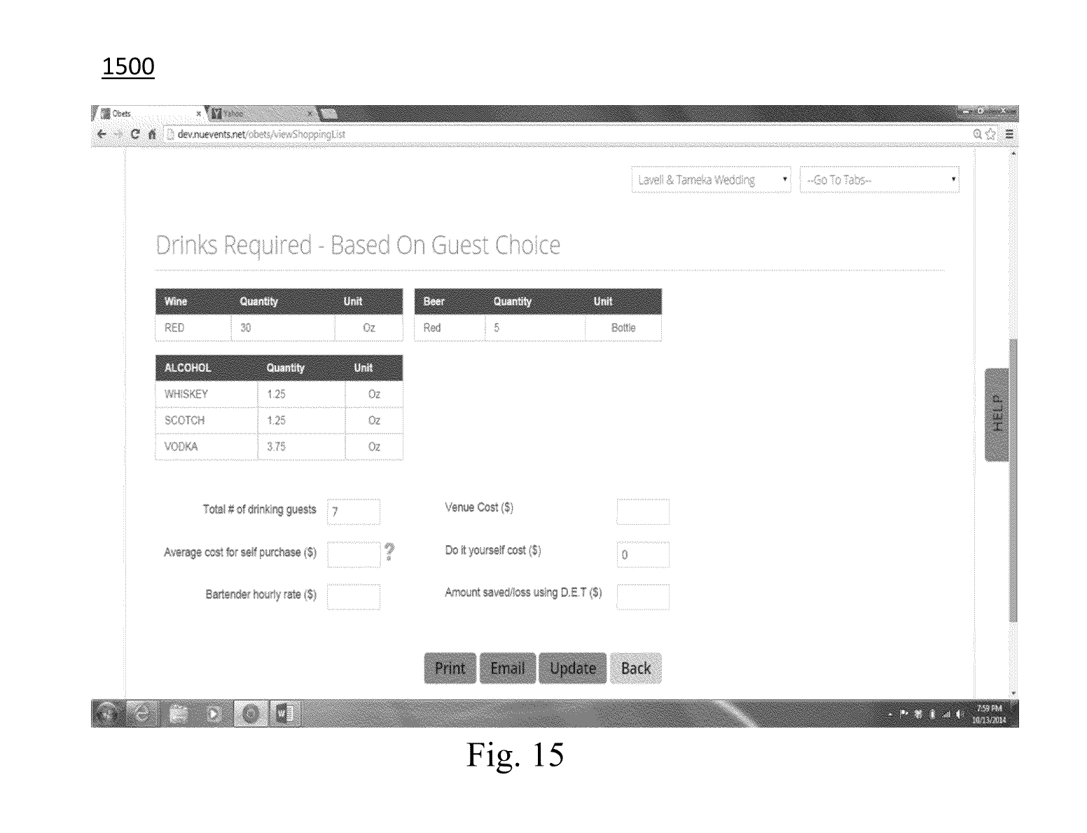

A snapshot screen display 1400 will also provide the percentages of guests drinking per category as shown in FIG. 14. The percentages are calculated by the total number of drinking guest and the percentages per each category. FIG. 15 is another screen shot 1500 that will help the user/host decide, after they get a estimation of how much the drinks will cost with a bartender compared to the venue (if need be), if it would be cheaper for them to provide the beverages themselves or simply use the venue's beverage services. In this comparison, a user/host can not only compare the costs of each possible beverage service, but also use that as a factor in their decision making process which takes into account other intangible factors such as ability and convenience.

The system is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for providing event beverage estimation executable by a machine and rendered on the display of the machine, comprising the steps of:
providing on and executing by a computer;
an event management and RSVP application where users/hosts can create their event and let guests RSVP to the event either online or using an application;
a database providing one or more drink category options and one or more drinks for each category;
creating a drink menu with one or more drink offering categories;
offering one or more of the drink categories to guests for selection when RSVP'ing.

2. The method of claim 1, wherein the drink menu is separated into four categories; beer, wine, champagne, and mixed drinks.

3. The method of claim 1, wherein four drink categories are offered, wine, beer, champagne, and mixed drinks.

4. The method of claim 3, wherein wine is broken down to either red or white.

5. The method of claim 3, wherein for beer, beers are selected from a database which will then generate a list presented to guest for selection when they RSVP.

6. The method of claim 3, wherein Champagne is either yes or no.

7. The method of claim 3, wherein for Mixed Drinks, further comprising the steps of:
selecting the alcohol type(s) which will be available for selection by guests RSVP'ing;
offers a list of the top mixers with each alcohol type and helps estimate how much of each mixer is needed; and
creating signature drinks selected from the database which are then available for selection by guests RSVP'ing.

8. The method of claim 1, wherein, under drink limit, the user/host can set
the time the bar will be open in a duration of hours;
whether drinks will be measured; and
setting maximum number of drinks per guest.

9. The method of claim 1, wherein, for each drink category, calculating and/or entering a percentage of guests who may drink from that specific drink category compared to other offerings.

10. A program storage device readable by a machine, tangibly embodying a program of instructions executable by the machine to perform method steps for providing event beverage estimation, said method steps comprising:
providing a database of one or more drink category options and one or more drinks for each category;
selecting one or more drink categories and one or more drinks from each selected drink category;
creating a drink menu with one or more drink offering categories and drinks;
offering one or more of the drink categories to guests for selection when RSVP'ing;
calculating and/or entering a percentage of guests who may drink more of one category compared to other categories;
generating a drink report; and
generating a drink shopping report.

11. The method of claim 10, wherein the drink menu is separated into four categories; beer, wine, champagne, and mixed drinks.

12. The method of claim 10, further comprising the steps of:
setting the time the bar will be open in a duration of hours;
electing whether drinks will be measured; and
setting a maximum number of drinks per guest.

13. The method of claim 12, further comprising the step of:
calculating and/or entering a percentage of guests who may drink beer compared to other offerings

14. The method of claim 13, wherein, for each drink category, calculating and/or entering a percentage of guests who may drink from that specific drink category compared to other offerings.

15. The method of claim 12, wherein wine is broken down to either red or white.

16. The method of claim 12, further comprising the step of:
selecting beers from a database which will then generate a list presented to guest for selection when they RSVP.

17. The method of claim 12, wherein Champagne is either yes or no.

18. The method of claim 12, further comprising the steps of:
selecting the alcohol type(s) which will be available for selection by guests RSVP'ing associated with mixed drinks;
creating signature drinks selected from the database which are then available for selection by guests RSVP'ing; and
recording guest selections of alcohol type(s) and associated mixed drinks selected while RSVP'ing.

19. The method of claim 18, further comprising the steps of:
generating a list of the top mixers with each alcohol type based on recorded guest selections while RSVP'ing; and
estimating how much of each mixer is needed.

20. The method of claim 19, wherein,
the drink report includes a list of selected alcohol types and mixed drinks selected; and
the drink report includes the amount and type/brand of each alcohol and mixer needed.
